(19) United States
(12) Patent Application Publication
(10) Pub. No.: US 2007/0152909 A1
(43) Pub. Date: Jul. 5, 2007

(54) Led device

(75) Inventors: Kazuo Fukuda, Gunma-Ken (JP); Tsutomu Fujino, Gunma-Ken (JP); Masami Yasumoto, Tottori-ken (JP); Mitsuhiro Omae, Tottori-Ken (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Osaka (JP)

(21) Appl. No.: 11/326,096

(22) Filed: Jan. 5, 2006

(51) Int. Cl. G09G 3/14

(52) U.S. Cl. 345/46

(57) ABSTRACT

An LED device comprises first to N-th (N is an integer of 2 or more) LEDs each having one end connected to one another and having different emission colors, and first to N-th transistors each having one end connected to the other ends of the individual LEDs and the other end connected to one another. The first to N-th transistors configure a current mirror circuit. A drive current supplied from outside is distributed to the individual LEDs at a current ratio corresponding to a size ratio of the individual transistors.

### BACKGROUND OF THE INVENTION

### Cross-Reference to Related Application

The entire disclosure of Japanese Application No. 2004-307135including the specification, claims, drawings, and abstract are incorporated herein by reference.

1. Field of the Invention

The present invention relates to an LED device provided with multiple LEDs (Light Emitting Diodes) having different emission colors (emitting light of different colors).

2. Description of the Related Art

There is a conventional structure that a monochrome LED is coated with a phosphor so that the LED will emit light of a desired color light. However, because the wavelength component of the light emitted by the LED is limited by the color of the monochrome LED and the wavelength of the phosphor, when such LED is used for the backlight of a liquid crystal panel, its color rendering properties are poor. For example, when white light emission is realized by coating a yellow phosphor to a blue LED, the red color rendering property is poor.

Meanwhile, there is another known structure of realizing a desired color light emission by the LED in that plural monochrome LEDs are combined, and currents flowing to the individual LEDs are controlled by a semiconductor device or the like. FIG. 10 is a diagram showing an example structure in which white light emission is realized by three LEDs of different colors. FIG. 10 shows a blue LED (BLED), a green LED (GLED), and a red LED (RLED) connected to respective variable resistors VR1, VR2, and VR3. A current control circuit 91 controls the resistance values of the individual variable resistors such that a ratio of currents flowing to the individual LEDs corresponds to that required to realize white light emission.

Although with this structure the combination of three RGB LEDs enables the realization of outstanding color rendering properties, as can be seen from FIG. 10, a structure in which a plurality of LEDs are combined necessitates that the currents flowing to the individual LEDs be independently controlled in order to obtain desired luminance and color, such that the circuit for the drive control becomes complex.

### SUMMARY OF THE INVENTION

The present invention provides an LED device comprising first to N-th (N is an integer of 2 or more) LEDs each having one end connected to one another and having different emission colors; and first to N-th transistors each having one end connected to the other ends of the individual LEDs and the other end connected to one another, wherein the first to N-th transistors configure a currentmirror circuit, and a drive current supplied from outside is distributed to the individual LEDs at a current ratio corresponding to a size ratio of the individual transistors.

### BRIEF DESCRIPTION OF THE DRAWINGS Preferred embodiments of the present invention will be described in further detail based on the following drawings, wherein:

FIG. 1 is a circuit diagram showing a structure of the LED device according to a first embodiment of the present invention;

FIG. 2 is an external perspective view showing the structure of the LED device according to the first embodiment;

FIG. 3 is a sectional view taken along line S-S of FIG. 2;

FIG. 4 is a circuit diagram showing a structure of the LED device according to a second embodiment of the present invention;

FIG. 5 is a circuit diagram showing a structure of the LED device according to a third embodiment of the present invention;

FIG. 6 is a diagram showing an example layout of MOS transistors on a chip;

FIG. 7 is a diagram showing an example of a preferable layout of the MOS transistors;

FIG. 8 is a circuit diagram showing a structure of an LED device which is a cathode common;

FIG. 9 is a circuit diagram showing a structure of an LED device using NPN-type BIP transistors;

FIG. 10 is a diagram showing an example of a structure which realizes white light emission by three color LEDs; and

FIG. 11 is a diagram showing a relationship between a total current of three LEDs and the currents flowing to the individual LEDs in the structure shown in FIG. 10.

### DESCRIPTION OF THE PREFERRED EMBODIMENTS

Embodiments of the present invention will be described with reference to the drawings.

### First Embodiment

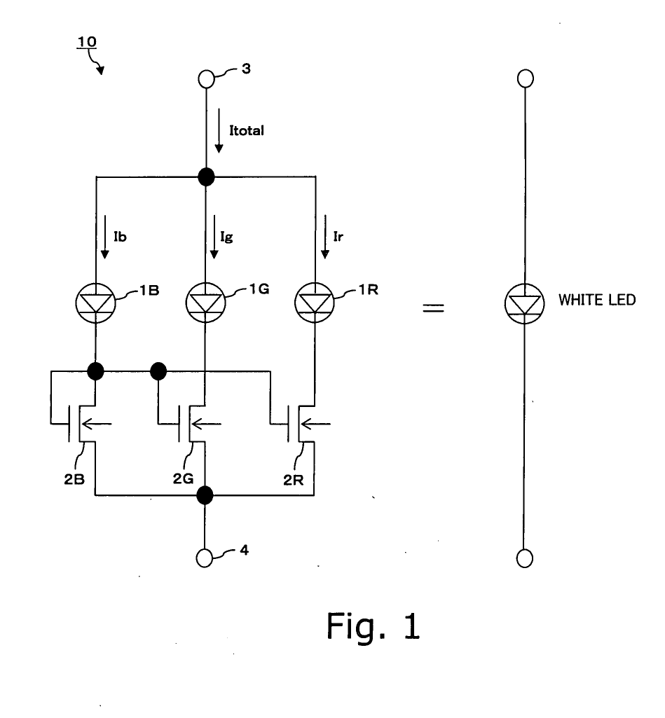

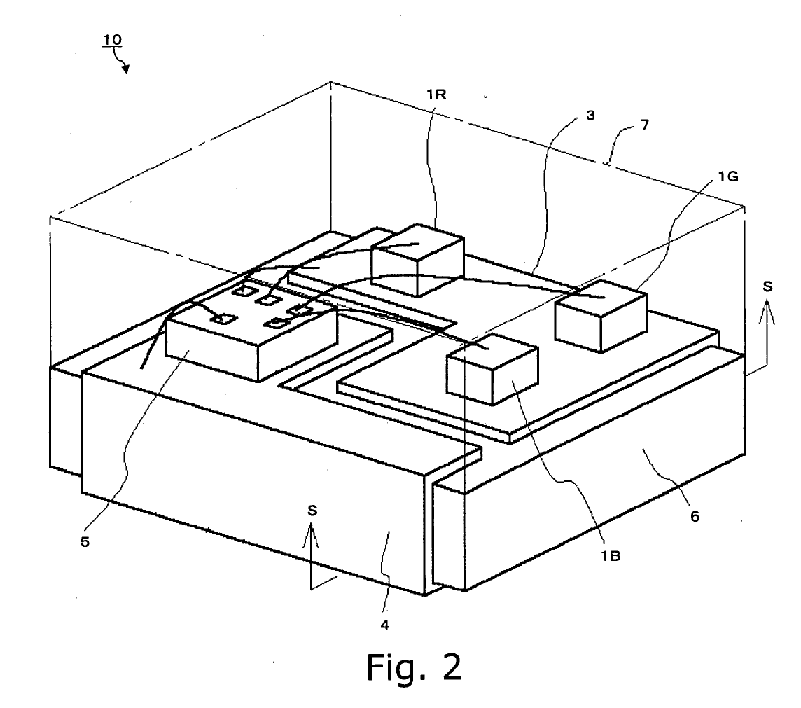

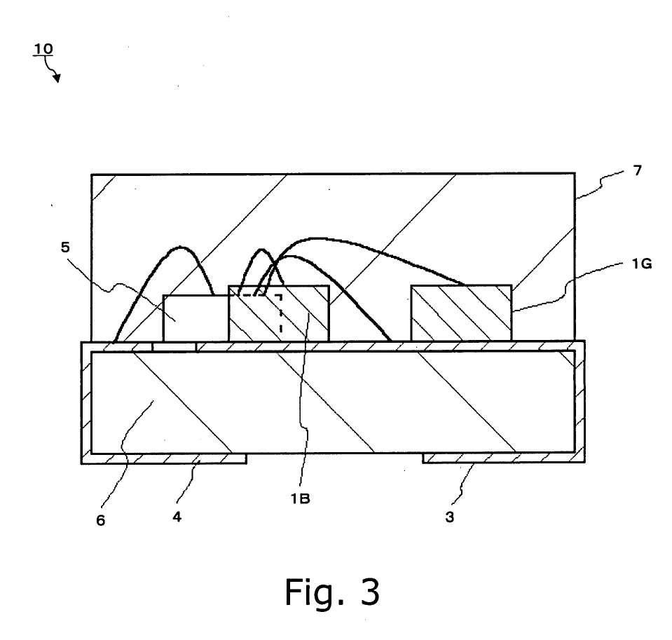

FIG. 1 is a circuit diagram showing a structure of an LED device 10 according to a first embodiment of the present invention. FIG. 2 is an external perspective view showing the structure of the LED device 10 according to this embodiment. FIG. 3 is a sectional view taken along line S-S of FIG. 2. The LED device 10 is particularly suitable as the backlight for a liquid crystal panel and also useful in various applications such as a cellular phone's flash light, alight, an electric bulletin board, a traffic signal, general illumination applications, and the like.

The LED device 10 includes a plurality of LEDs each emitting light of a different color and combines the light of the individual LEDs to emit light of a prescribed color. In this example, the LED device 10 has a blue LED 1B, a green LED 1G, and a red LED 1R, and functions as a white LED which emits white light. The number of LEDs, the emission colors of the individual LEDs, and the emission color or colors of the LED device 10 are not limited to those of the present example.

In FIG. 1, the LED device 10 has N-channel type MOS transistors 2B, 2G, 2R which are disposed in correspondence with the LEDs 1B, 1G, 1R. Anodes of the individual LEDs 1B, 1G, 1R are connected to one another and connected to the same and one node 3. Meanwhile, cathodes of the LEDs 1B, 1G, 1R are connected to drains of the corresponding MOS transistors 2B, 2G, 2R. Sources of the MOS transistors 2B, 2G, 2R are connected to one another and connected to the same and one node 4.

The drain and gate of one MOS transistor (MOS transistor 2B in FIG. 1) among the plurality of MOS transistors 2B, 2G, 2R are connected, and the gates of the MOS transistors 2B, 2G, 2R are commonly connected. Thus, the MOS transistors 2B, 2G, 2R configure a current mirror circuit.

The size ratio of the MOS transistors 2B, 2G, 2R is determined according to a ratio Ib:Ig:Ir of the currents flowing to the individual LEDs when light of the desired color is output. Here, Ib, Ig, and Ir respectively denote current values flowing to the LEDs 1B, 1G, 1R. Specifically, when Ib:Ig:Ir=a:b:c and the LED device 10 emits desired color light, the size ratio of the MOS transistors 2B, 2G, 2R is set to a:b:c. In the present example, when Ib:Ig:Ir=1:2:3, the LED device 10 emits white light, and the size ratio of the MOS transistors 2B, 2G, 2R is set to 1:2:3.

In the above structure, when a drive current Itotal is supplied from an outside drive circuit to the node 3, the drive current Itotal is distributed to flow to the LEDs 1B, 1G, 1R at a current ratio corresponding to the size ratio of the MOS transistors 2B, 2G, 2R. Specifically, the ratio Ib:Ig:Ir of the currents flowing to the LEDs 1B, 1G, 1R becomes substantially the same as the size ratio 1:2:3 of the MOS transistors 2B, 2G, 2R, and the LED device 10 emits white light.

Next, a suitable physical structure of the LED device 10 will be described. As shown in FIGS. 2 and 3, the LEDs 1B, 1G, 1R, an IC 5 including the MOS transistors 2B, 2G, 2R, and the nodes 3, 4 are disposed on the same and one substrate 6 to configure a single module. The individual LEDs 1B, 1G, 1R and the IC 5 are connected to one another by wire bonding. And, the LEDs 1B, 1G, 1R and the IC 5 are covered with a translucent resin 7.

In this embodiment described above, the drive current which is supplied from the outside to the LED device is automatically distributed by a current mirror to the individual LEDs at a current ratio corresponding to the size ratio of the individual transistors, and the individual LEDs emit light at a luminance ratio corresponding to the current ratio, and the LED device emits prescribed color light. Therefore, driving of the LED device according to the present embodiment can be controlled by a driver with a simple structure. Thus, an outside drive control circuit can be made simple, compact, and inexpensive.

In other words, a user of the LED device can obtain a desired emission color (here, white) simply, by supplying the LED device with a drive current in the same manner as the case of driving a single LED. Accordingly, the user need not arrange for independent control of the currents flowing to the plurality of LEDs and can operate the LED device as if it were a single white LED. Therefore, the user can use the drive circuit for the single LED as the drive control circuit of the LED device without modifying or reconfiguring the drive circuit. Thus, the LED device according to this embodiment is a very useful module for the user and can be used as if a single LED is controlled.

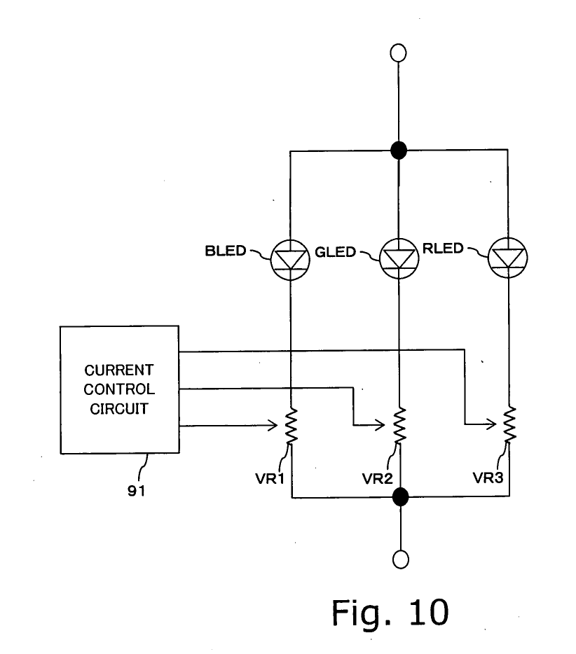

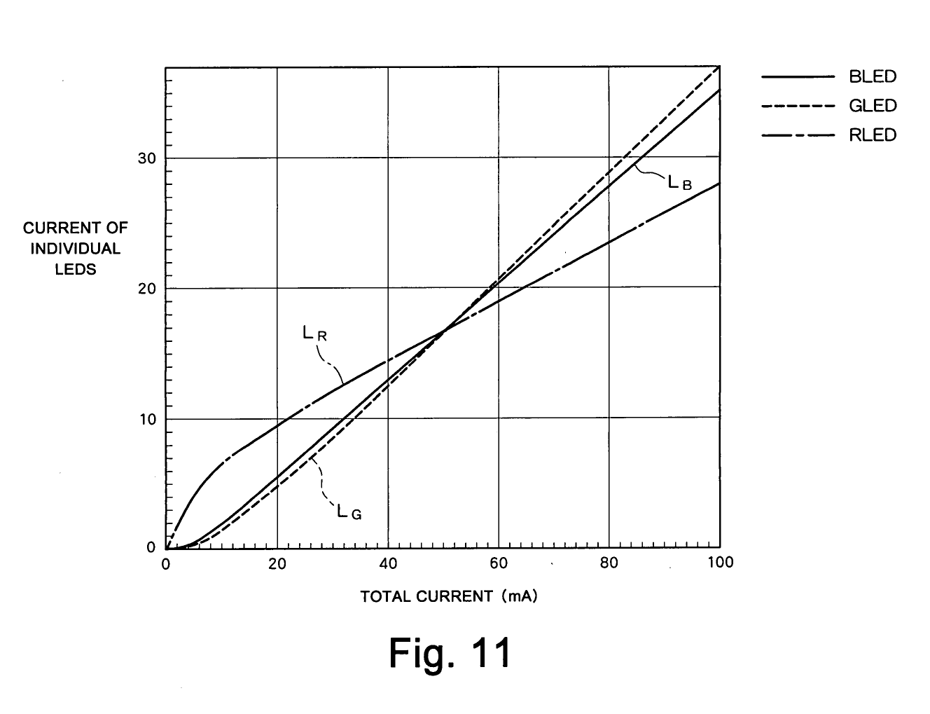

The above-described effects will next be described in comparison with the conventional structure shown in FIG. 10. FIG. 11 is a diagram showing a relationship between a total current flowing to the three LEDs and the currents flowing to the individual LEDs of FIG. 10. In FIG. 11, solid line L_{B}, dotted line L_{G}, and dashed line L_{R} represent current values flowing to BLED, GLED, and RLED, respectively. Additionally, it can be seen from FIG. 11 that the resistance values of the individual variable resistors of FIG. 10 are set such that a ratio of currents flowing to the individual LEDs becomes 1:1:1 when a total current is 50 mA. As apparent from FIG. 11, when the individual resistance values are fixed in conjunction with the structure shown in FIG. 10, the current ratio is varied if the total current is varied. Specifically, when the total current is increased to be larger than 50 mA, the ratio of current flowing to the RLED becomes small, and when the total current is decreased to be smaller than 50 mA, the ratio of current flowing to the RLED becomes large. Meanwhile, the current ratio of the individual LEDs in this embodiment is determined according to the size ratio of the individual transistors and substantially constant even if the total current is varied. Therefore, when the total current is to be varied while the current ratio is maintained at a desired level, the structure shown in FIG. 10 must vary the resistance values of the individual variable resistors every time the total current is varied, such that the control becomes complex. The configuration of the present embodiment, however, advantageously eliminates any need for such complex control.

### Second Embodiment

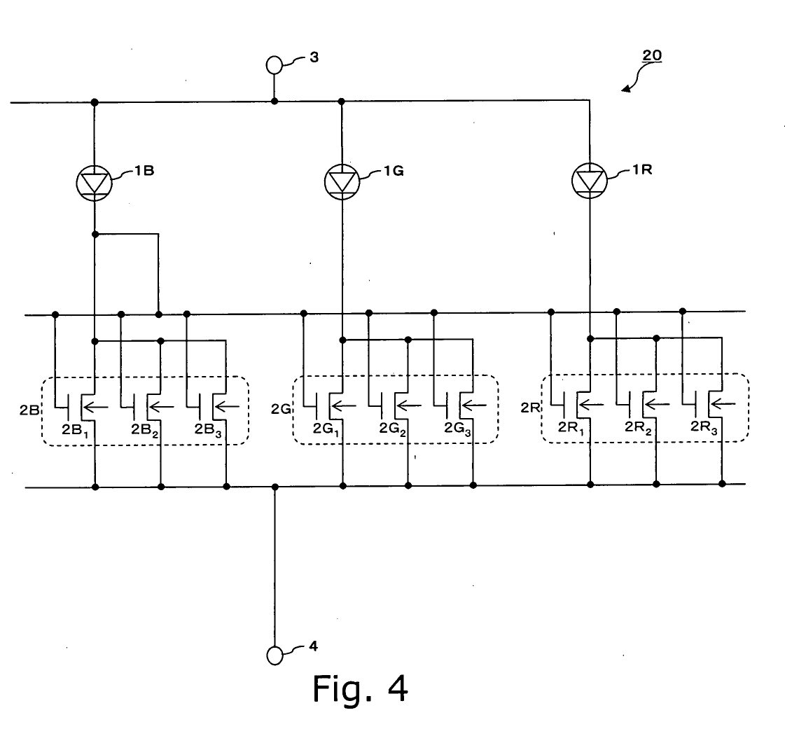

FIG. 4 is a circuit diagram showing the structure of an LED device 20 according to a second embodiment of the present invention. The LED device 20 according to this embodiment is substantially the same as the above-described LED device 10 but has a variable ratio of currents distributed to the individual LEDs. Specifically, all or a portion of the transistors disposed in correspondence with the individual LEDs in this embodiment are comprised of a plurality of transistors which are connected in parallel with one another including an ON/OFF switchable adjusting transistor and the ratio of currents distributed to the individual LEDs can be varied through the ON/OFF operation of the adjusting transistor. The LED device 20 will next be described, wherein corresponding reference numerals are used for parts corresponding to those of the LED device 10. Detailed description of components previously described will not be repeated.

As used in this specification, the term “ON/OFF switchable” includes configurations in which ON and OFF can be switched repeatedly, switching from ON to OFF can be effected only once, and switching from OFF to ON can be effected only once.

In FIG. 4, a MOS transistor 2B is comprised of three MOS transistors 2B₁, 2B₂, 2B₃ which are connected in parallel with one another. Similarly, a MOS transistor 2G is comprised of MOS transistors 2G₁, 2G₂, 2G₃, and a MOS transistor 2R is comprised of MOS transistors 2R₁, 2R₂, 2R₃. Among these nineMOS transistors, the MOS transistors 2B₂, 2B₃, 2G₂, 2G₃, 2R₂, 2R₃ are adjusting transistors which are ON in the initial state and can be set to OFF by zapping. Here, zapping methods include, for example, a method of breaking a zapping element such as a resistor, a zener diode, or the like with an electric current or a laser, but is not limited to a particular method. The size ratio of the MOS transistors 2B₁, 2B₂, 2B₃, that of 2G₁, 2G₂, 2G₃, and that of 2R₁, 2R₂, 2R₃ are determined appropriately depending on the purpose of adjustment. Here, the above size ratios are set to 9:1:1 for fine adjustment of the emission color (current ratio).

In the above-described structure, the adjusting transistor is used to adjust the current ratio. Specifically, to lower a ratio of current flowing to a certain LED, the adjusting transistor corresponding to the pertinent LED is turned OFF, while to increase a ratio of current flowing to a certain LED, the adjusting transistors corresponding to LEDs other than the pertinent LED are turned OFF.

More specifically, the adjusting transistor is used as follows. Because the luminous efficiency of the LEDs is not uniform, there is variation in the luminance of the LEDs even when the same current flows. Therefore, the user measures the luminance of the LED in the initial state, and then turns OFF the adjusting transistor to adjust a ratio of currents flowing to the individual LEDs to realize a desired color. For example, where the LED 1R has high luminance and the emission color of the LED device 20 is reddish white, the user turns OFF the MOS transistor 2R₁ or 2R₂ to obtain a desired emission color white.

As described above, all or a portion of the transistors disposed in correspondence with the individual LEDs in this embodiment are comprised of multiple transistors which include the ON/OFF switchable adjusting transistor. Therefore, a ratio of currents flowing to the individual LEDs can be adjusted by turning ON or OFF the adjusting transistor. Thus, the emission color of the LED device can be adjusted. And, the adjusting transistor is turned OFF by zapping, so that the adjustment of the current ratio can be realized by a simple structure.

Although the example described above is configured such that the adjusting transistor is turned OFF by zapping, the device may also be configured such that the adjusting transistor is turned ON by zapping.

### Third Embodiment

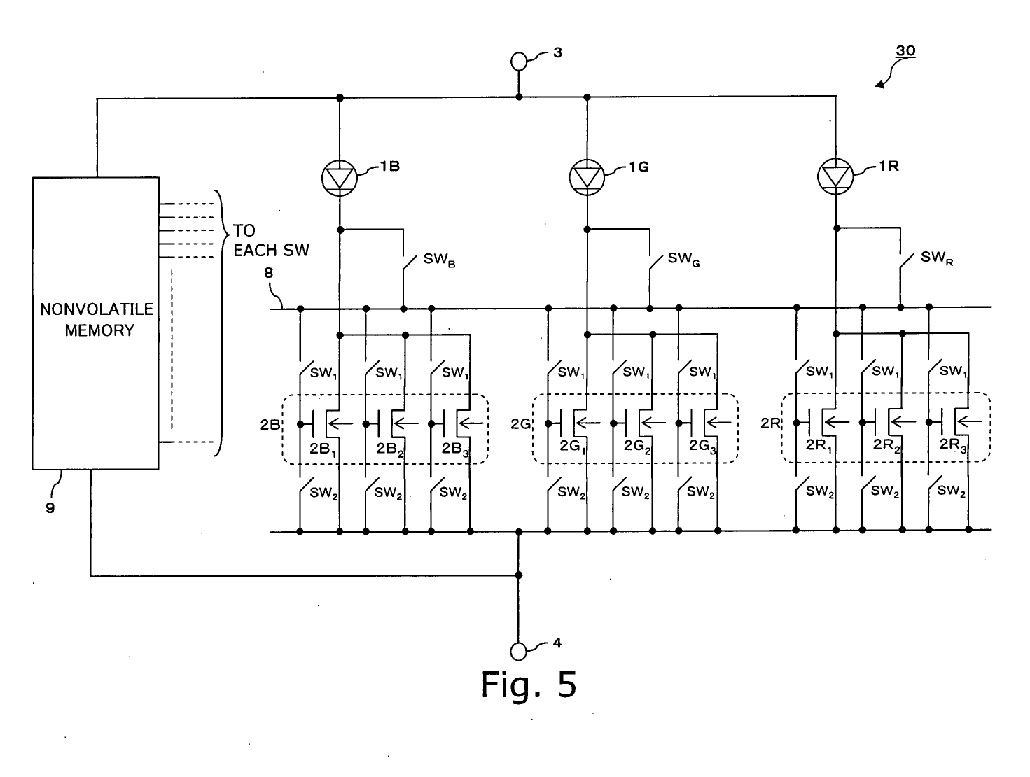

FIG. 5 is a circuit diagram showing a structure of an LED device 30 according to this embodiment. The LED device 30 according to this embodiment has switches to turn ON and OFF adjusting transistors. Specifically, the LED device 30 is provided with a rewritable memory and switches which turn ON and OFF the adjusting transistors according to data stored in the memory. And, when the data in the memory is rewritten, the ratio of currents distributed to the individual LEDs is varied. The LED device 30 will be described below, wherein corresponding reference numerals are used for parts corresponding to those of the LED devices 10, 20. As above, detailed description of components previously described will not be repeated.

As shown in FIG. 5, the transistors corresponding to the individual LEDs of the LED device 30 are comprised of three transistors connected in parallel to one another in the same manner as in the LED device 20. Specifically, the MOS transistor 2B is comprised of MOS transistors 2B₁, 2B₂, 2B₃, the MOS transistor 2G is comprised of MOS transistors 2G₁, 2G₂, 2G₃, and the MOS transistor 2R is comprised of MOS transistors 2R₁, 2R₂, 2R₃. In this embodiment, these nine MOS transistors are adjusting transistors which are disposed to be ON/OFF switchable. The size ratio of the MOS transistors 2B₁, 2B₂, 2B₃, that of 2G₁, 2G₂, 2G₃, and that of 2R₁, 2R₂, 2R₃ are determined appropriately depending on the purpose of adjustment. Here, the above size ratios are set to 4:2:1 to realize not only white, but also various other emission colors.

Anodes of the individual LEDs 1B, 1G, 1R are connected to one another and connected to the same and one node 3. Meanwhile, cathodes of the LEDs 1B, 1G, 1R are connected to the drains of the corresponding three MOS transistors, and the sources of the nine MOS transistors are connected to one another and connected to the same and one node 4.

The cathodes of the LEDs 1B, 1G, 1R are connected to a common line 8 via individual switches SW_{B}, SW_{G}, SW_{R}. And, the nine MOS transistors each are provided with two switches SW₁, SW₂, and the gates of the individual MOS transistors are connected to the common line 8 via the switches SW₁ and to the node 4 via the switches SW₂.

The above-described individual switches are set to turn ON or OFF so as to meet the following conditions. Specifically, among the switches SW_{B}, SW_{G}, SW_{R}, one switch is turned ON, but two or more switches do not become ON at the same time, while one of the switches SW₁, SW₂ is turned ON while the other is turned OFF, and both of them are not turned ON or OFF at the same time. When all the three switches SW₁ corresponding to the LED 1B are OFF, the switch SW_{B} is OFF. Similarly, when all the three switches SW₁ corresponding to the LED 1G are OFF, the switch SW_{G} is OFF, and when all the three switches SW₁ corresponding to the LED 1R are OFF, the switch SW_{R} is OFF.

The LED device 30 is provided with a nonvolatile memory 9 which is rewritable from outside. Data indicating ON/OFF of the above-described individual switches is stored in the nonvolatile memory 9. These switches are set to ON or OFF according to the data stored in the nonvolatile memory 9, and the individual MOS transistors are set to ON or OFF accordingly.

Here, a relationship between ON/OFF of the individual switches and ON/OFF of the MOS transistors in the above-described structure will be described. Here, it is assumed that the switch SW_{B} is ON, and the switches SW₁ corresponding to the MOS transistors 2B₁, 2G₁, 2G₃, 2R₂ are ON, and the other switches SW₁ are OFF. In this case, the MOS transistor 2B₁ has the gate and the drain short-circuited and is in an ON state. The gates of the MOS transistors 2G₁, 2G₃, 2R₂ are commonly connected with the gate of the MOS transistor 2B₁ to form a current mirror in cooperation with the MOS transistor 2B₁ and MOS transistors 2G₁, 2G₃, 2R₂ are in an ON state. Meanwhile, the gate and source of the other MOS transistors are short-circuited and the other MOS transistors are in an OFF state because the corresponding switches SW₂ are ON. Thus, the individual MOS transistors become ON when the corresponding switches SW₁ are ON and become OFF when the corresponding switches SW₂ are ON. In the above case, the MOS transistors 2B, 2G, 2R have a size ratio of
{1×(4/7)}:{2×(5/7)}:{3×(2/7)}.

In the above-described structure, the individual MOS transistors are set to ON or OFF by the individual switches according to the data stored in the nonvolatile memory 9. Therefore, a ratio of currents distributed to the individual LEDs is determined according to the data in the nonvolatile memory 9 and varied when the data in the nonvolatile memory 9 is rewritten, while a ratio Ib:Ig:Ir of currents distributed to the LEDs 1B, 1G, 1R could be a ratio represented by {1×(D_{B}/7)}:{2×(D_{G}/7)}:{3×(D_{R}/7)}(D_{B}, D_{G}, D_{R} are integers of 1 or more and 7 or less). Therefore, the LED device 30 according to this embodiment is able to realize a very wide range of emission colors.

As described above, all or a portion of the transistors disposed in correspondence with the individual LEDs of this embodiment are configured of the plural transistors including the ON/OFF switchable adjusting transistor. Therefore, a ratio of currents flowing to the individual LEDs can be adjusted by turning ON/OFF the adjusting transistor. Thus, the emission color of the LED device can be adjusted. The transistors are turned ON/OFF by the switches according to the data in the memory, so that the individual transistors can be turned ON/OFF repeatedly, incontrast to the situation when the transistors are zapped. Therefore, the user can repeatedly obtain various emission colors by rewriting the data in the memory from outside.

In this embodiment, because the nonvolatile memory is used as the memory, the power supply for keeping data and data writing for every ON/OFF of the power can be eliminated. Therefore, when data corresponding to, for example, white is once written in the memory, additional data writing is not required, and the LED device can be operated as if it is a single white LED. The above memory may be a volatile memory.

The quantity and positions of the switches are not limited to the above description and can be determined as desired, as long as the MOS transistors can be turned ON/OFF.

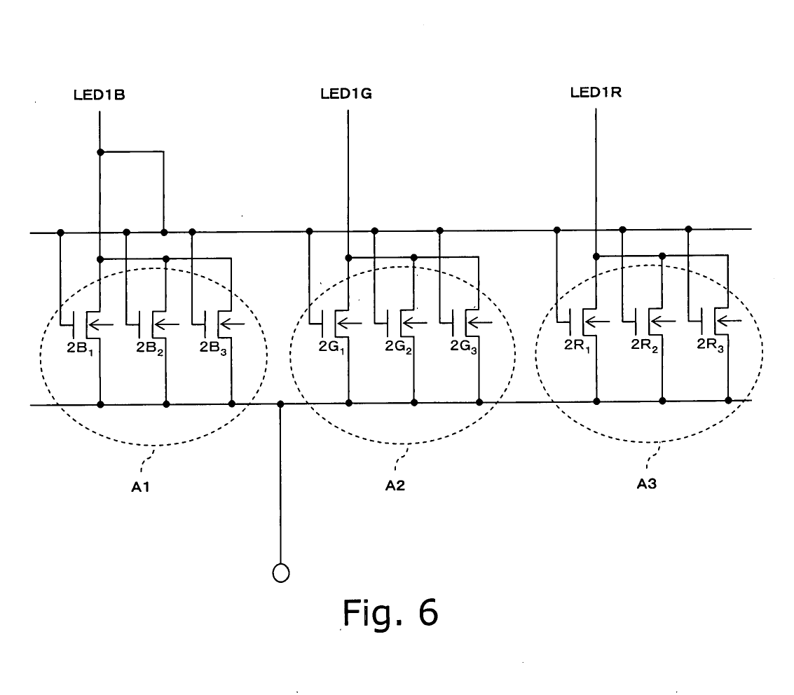

Example suitable positions of the MOS transistors according to the second or third embodiment will be described below. FIG. 6 is a diagram showing an example layout of the MOS transistors on a chip. FIG. 6 is not a mere circuit diagram but shows a circuit structure and the arrangement of the MOS transistors. In the example layout of FIG. 6, the MOS transistors 2B₁, 2B₂, 2B₃ corresponding to the LED 1B are disposed close to one another in an area A1. The MOS transistors 2G₁, 2G₂, 2G₃ corresponding to the LED 1G are disposed close to one another in an area A2. The MOS transistors 2R₁, 2R₂, 2R₃corresponding to the LED 1R are disposed close to one another in an area A3. In other words, the MOS transistors 2B, 2G, 2R each are formed in different areas on the chip. Therefore, the size ratio of the MOS transistors 2B, 2G, 2R in the layout shown in FIG. 6 is variable relatively widely depending on the in-plane variation of the transistor characteristics. Here, the in-plane variation of the transistor characteristics is caused by a variation in oxide film thickness, displacement of a mask or the like.

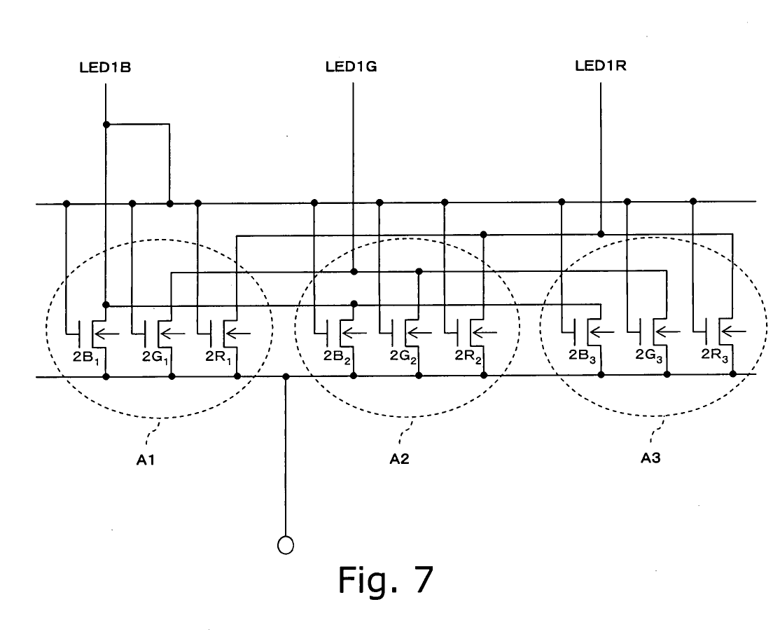

To decrease the variation in the size ratio of the transistors, it is preferable that the MOS transistors are disposed as shown in FIG. 7. FIG. 7 is not a mere circuit diagram but shows a circuit structure and also the arrangement of the MOS transistors. According to the layout example of FIG. 7, the MOS transistors 2B₁, 2G₁, 2R₁ are disposed close to one another in the area A1, the MOS transistors 2B₂, 2G₂, 2R₂ are disposed close to one another in the area A2, and the MOS transistors 2B₃, 2G₃, 2R₃ are disposed close to one another in the area A3. Specifically, the MOS transistors 2B, 2G, 2R are similarly disposed to disperse in the areas A1, A2, A3. On the whole, they may be said formed in the same area. Therefore, according to the layout shown in FIG. 7, a variation in the size ratio of the MOS transistors 2B, 2G, 2R due to an in-plane variation of the transistor characteristics can be reduced. As a result, variation of the ratio of currents distributed to the individual LEDs can be reduced.

As described above, when the plurality of MOS transistors are disposed in correspondence with the plurality of LEDs, it is desirable that a plurality of corresponding MOS transistors is similarly disposed to disperse in plural areas for the individual LEDs. Specifically, when k (k is an integer of 2 or more) MOS transistors are disposed in correspondence with individual j (j is an integer of 2 or more) LEDs, it is preferable that a total of j MOS transistors, each including one MOS transistor corresponding to each LED, is determined as a unit transistor group, and a total of k unit transistor groups is disposed in k areas for each unit transistor group such that the j MOS transistors included in the unit transistor group are disposed close to one another.

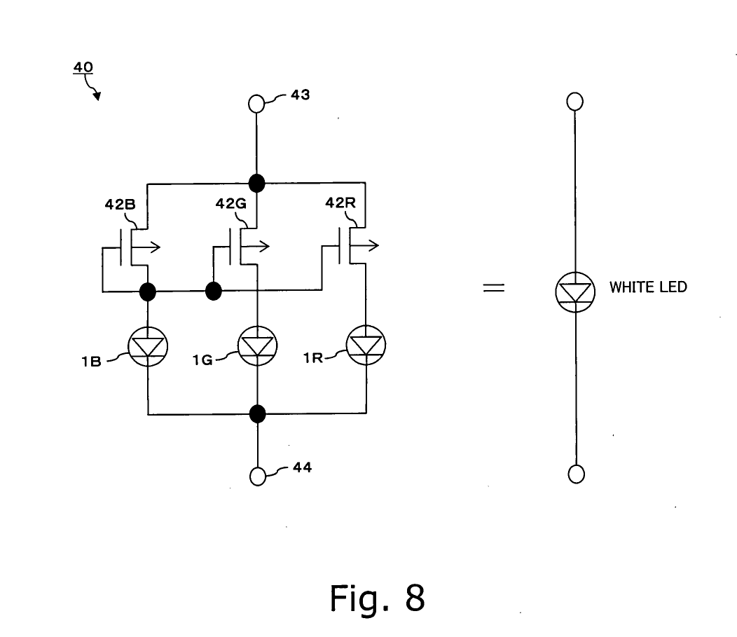

Although illustrative embodiments of the present invention were described above, it is to be understood that the present invention is not limited to the above-described embodiments. For example, the above embodiments were described with reference to the anode common, but it may be a cathode common. FIG. 8 is a circuit diagram showing a structure of an LED device 40 which is a cathode common. In FIG. 8, P-channel type MOS transistors 42B, 42G, 42R are disposed in correspondence with LEDs 1B, 1G, 1R. The cathodes of the LEDs 1B, 1G, 1R are commonly connected and connected to a node 44. Meanwhile, the anodes of the LEDs 1B, 1G, 1R are connected to the drains of the corresponding MOS transistors 42B, 42G, 42R. Individual sources of the MOS transistors 42B, 42G, 42R are commonly connected and connected to a node 43.

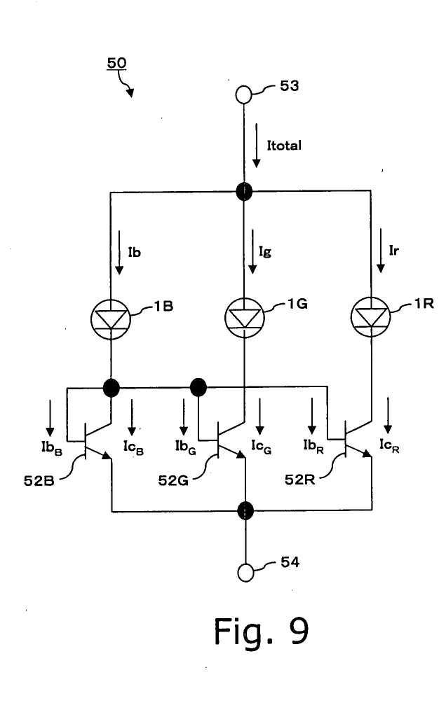

Also, the above-described embodiments were described with reference to MOS transistors as an example, NPN-type or PNP-type bipolar transistors (BIP transistor) may be used instead of the MOS transistors. FIG. 9, for example, is a circuit diagram showing a structure of an LED device 50 using NPN-type BIP transistors. In FIG. 9, NPN-type BIP transistors 52B, 52G, 52R are disposed in correspondence with the LEDs 1B, 1G, 1R instead of the MOS transistors 2B, 2G, 2R of FIG. 1. In this structure, when it is assumed that current amplification factors (hfe) of the BIP transistors 52B, 52G, 52R are 99, 74, 99 respectively, ratios (Ib_{B}:Ic_{B}), (Ib_{G}:Ic_{G}), (Ib_{R}:Ic_{R}) of base currents and collector currents of the BIP transistors 52B, 52G, 52R become (1:99), (1:74), (1:99), respectively. Here, the individual BIP transistors have an equal base current Ib_{B}=Ib_{G}=Ib_{R}, so that a ratio Ib:Ig:Ir of currents flowing to the individual LEDs becomes about 100:75:100.

1. An LED device, comprising:
first to N-th (N is an integer of 2 or more) LEDs each having one end connected to one another and having different emission colors; and
first to N-th transistors each having one end connected to the other ends of the individual LEDs and the other end connected to one another, wherein:
the first to N-th transistors configure a current mirror circuit, and
a drive current supplied from outside is distributed to the individual LEDs at a current ratio corresponding to a size ratio of the individual transistors.

2. The LED device according to claim 1, wherein:
all or parts of the first to N-th transistors are comprised of plural transistors which include an ON/OFF switchable adjusting transistor and connected to one another in parallel, and
a ratio of currents distributed to the individual LEDs is varied depending on the ON/OFF state of the adjusting transistor.

3. The LED device according to claim 2, wherein the adjusting transistor is set to ON or OFF by zapping.

4. The LED device according to claim 2, further comprising:
a rewritable memory; and
a switch which turns ON or OFF the adjusting transistor according to data stored in the memory, wherein:
a ratio of currents distributed to the individual LEDs is varied by rewriting the data in the memory.

5. The LED device according to claim 4, wherein the memory is a nonvolatile memory.

6. The LED device according to claim 1, wherein light emitted from the first to N-th LEDs is mixed to form white light.
